(19) United States
(12) Patent Application Publication
(10) Pub. No.: US 2014/0208790 A1
(43) Pub. Date: Jul. 31, 2014

(54) COMPACT DESSICANT AND ZEOLITE BODIES FOR USE IN A DOWNHOLE SORPTION COOLING SYSTEM

(71) Applicant: BAKER HUGHES INCORPORATED, Houston, TX (US)

(72) Inventors: Erik Pennewitz, Braunschweig (DE); Thomas Kruspe, Wietzendorf (DE); Sebastian Jung, Isernhagen (DE)

(73) Assignee: BAKER HUGHES INCORPORATED, HOUSTON, TX (US)

(21) Appl. No.: 13/752,938

(22) Filed: Jan. 29, 2013

(51) Int. Cl. E21B 36/00; B23P 15/26; F25B 17/08

(52) U.S. Cl. CPC E21B 36/001; F25B 17/08; B23P 15/26
USPC 62/260; 29/890.035

(57) ABSTRACT

A sorption cooling apparatus for cooling a region in a downhole tool deployed on a wellbore conveyance device includes a container having an interior chamber in which a first region is formed, a liquid refrigerant residing in the interior chamber, a chamber located in a second region of the downhole tool, a compact desiccant body in the chamber, and a refrigerant passage between a first region containing the liquid refrigerant and the second region containing the compact desiccant body. The vapor generated during evaporation of the liquid refrigerant passes through the vapor passage to the compact desiccant in the second region.

### CROSS REFERENCE TO RELATED APPLICATIONS

None.

### BACKGROUND OF THE DISCLOSURE

1. Field of the Disclosure

The present disclosure is related to sorption cooling of a component of a downhole tool.

2. Background of the Art

The present disclosure is related to sorption cooling of a component of a downhole tool. One way to cool a device downhole includes evaporating a refrigerant stored on the downhole tool from a liquid phase to a gaseous phase. Once the evaporated refrigerant has cooled the component, it is generally stored at a desiccant or other body that adsorbs the gas-phase refrigerant in the downhole tool. Either downhole or at the surface, the refrigerant is removed from the desiccant by thermal heating or some other means.

Once the desiccant becomes saturated with refrigerant, the cooling operation ends. The present disclosure addresses the need for desiccants that can enhance cooling operations in wellbore environments.

### SUMMARY OF THE DISCLOSURE

In one aspect, the present disclosure provides a sorption cooling apparatus for cooling a region in a downhole tool deployed on a wellbore conveyance device includes a container having an interior chamber in which a first region is formed, a liquid refrigerant residing in the interior chamber, a chamber located in a second region of the downhole tool, a compact desiccant body in the chamber, and a refrigerant passage between a first region containing the liquid refrigerant and the second region containing the compact desiccant body. The vapor generated during evaporation of the liquid refrigerant passes through the vapor passage to the compact desiccant in the second region.

In another aspect, the present disclosure provides a sorption cooling apparatus for cooling a region in a downhole tool deployed on a wellbore conveyance device. The apparatus may include a container having an interior chamber in which a first region is formed, a liquid refrigerant residing in the interior chamber, a chamber located in a second region of the downhole tool, a consolidated, compact zeolite body in the chamber, and a refrigerant passage between the first region containing the liquid refrigerant and the second region containing the compact desiccant body. The compact zeolite body may be preformed into a shape complementary to the chamber and the compact zeolite body may be formed of individual zeolite particles having substantially no interstitial space. The vapor generated during evaporation of the liquid refrigerant passes through the vapor passage to the compact desiccant in the second region.

In still another aspect, the present disclosure provides a method for cooling a region in a downhole tool deployed on a wellbore conveyance device. The method may include forming an interior chamber in a first container associated with the downhole tool, the interior chamber having a liquid refrigerant, disposing a compact desiccant body in a chamber located in a second region of the downhole tool, wherein a refrigerant passage connects a first region containing the liquid refrigerant and the second region containing the compact desiccant body, and passing vapor generated during evaporation of the liquid refrigerant through the vapor passage to the compact desiccant in the second region.

Examples of certain features of the disclosure have been summarized rather broadly in order that the detailed description thereof that follows may be better understood and in order that the contributions they represent to the art may be appreciated. There are, of course, additional features of the disclosure that will be described hereinafter and which will form the subject of the claims appended hereto.

### BRIEF DESCRIPTION OF THE DRAWINGS

For a detailed understanding of the present disclosure, reference should be made to the following detailed description of the embodiments, taken in conjunction with the accompanying drawings, in which like elements have been given like numerals, wherein:

FIG. 1 is a schematic diagram of an exemplary drilling system for drilling a wellbore using an apparatus that can be operated according to the exemplary methods disclosed herein;

FIG. 2 shows an exemplary sorption cooling apparatus that includes a compact zeolite desiccant body in one embodiment of the present disclosure;

FIG. 3 shows an another exemplary sorption cooling apparatus that includes a compact zeolite desiccant body in one embodiment of the present disclosure; and

FIG. 4 shows a side view of an exemplary desiccant suitable for use in adsorbing refrigerant in the exemplary cooling apparatus of FIG. 3.

### DETAILED DESCRIPTION OF THE DISCLOSURE

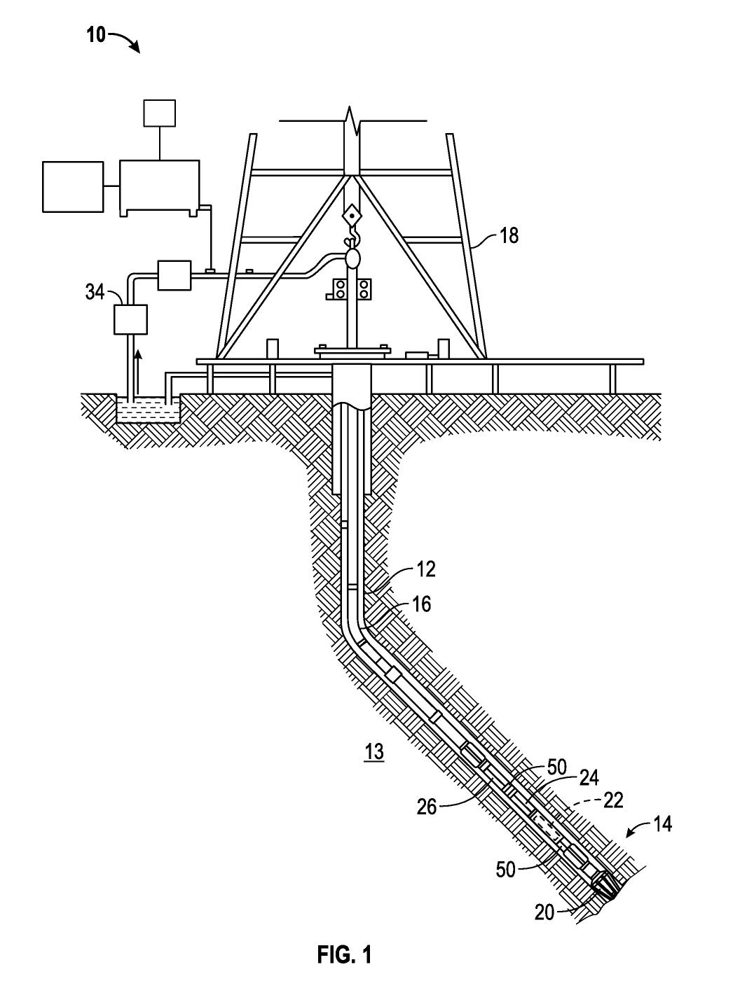

Referring now to FIG. 1, there is schematically illustrated a drilling system 10 for forming a wellbore 12 in an earthen formation 13. While a land-based rig is shown, these concepts and the methods are equally applicable to offshore drilling systems. Also, the wellbore 12 may include vertical sections, deviated sections, and horizontal sections, as well as branch wellbores. The drilling system 10 may use a bottomhole assembly (BHA) 14 conveyed by a rigid wellbore conveyance device such as a drill string 16 suspended from a rig 18. The drill string 16 may include a drill bit 20 at a distal end. The drill string 16 may be include any known drilling tubular adapted for use in a wellbore, e.g., jointed drill pipe, coiled tubing, casing, liner, etc.

The BHA 14 can also contain directional sensors and formation evaluation sensors or devices (also referred to as measurement-while-drilling, “MWD,” or logging-while-drilling, “LWD,” sensors) determining resistivity, density, porosity, permeability, acoustic properties, nuclear-magnetic resonance properties, corrosive properties of the fluids or formation downhole, salt or saline content, and other selected properties of the formation 13 surrounding the BHA 14. Such sensors are generally known in the art and for convenience are generally denoted herein by numeral 22. The BHA 14 can further include a variety of other sensors and communication devices 24 for controlling and/or determining one or more functions and properties of the BHA (such as velocity, vibration, bending moment, acceleration, oscillations, whirl, stick-slip, etc.) and drilling operating parameters, such as weight-on-bit, fluid flow rate, pressure, temperature, rate of penetration, azimuth, tool face, drill bit rotation, etc. A suitable telemetry sub 26 using, for example, two-way telemetry, is also provided as illustrated in the BHA 14 and provides information from the various sensors and to the surface.

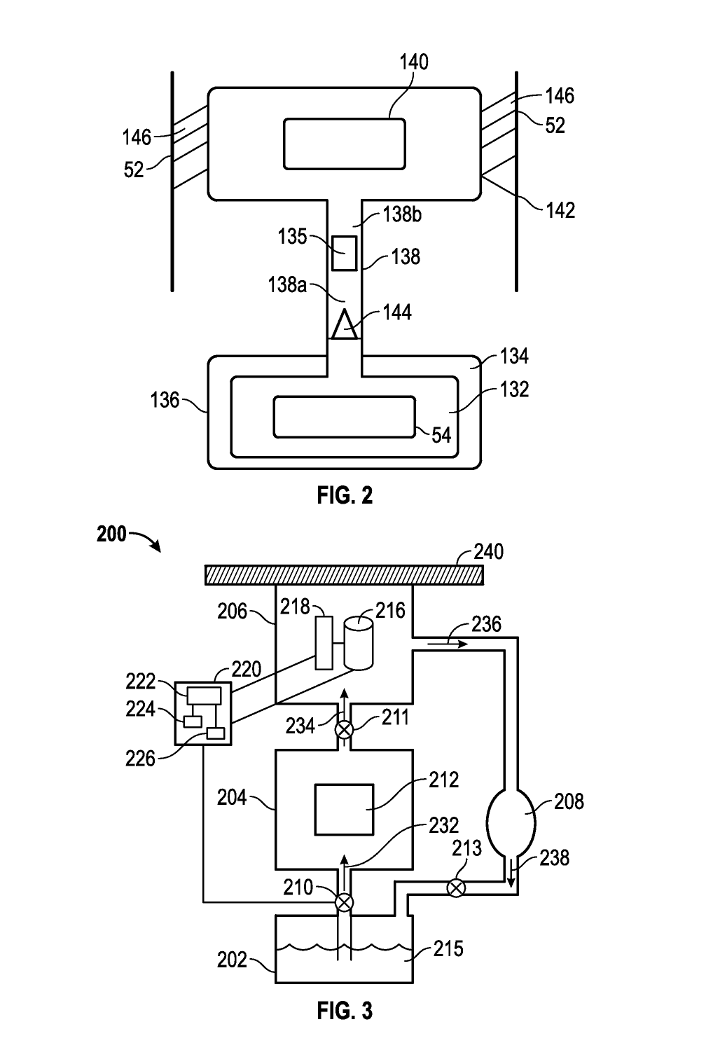

Bottomhole assembly 14 can also include one or more cooling systems 50 configured to cool the various electronic or sensor components of the BHA 14. These various electronic components can include the formation evaluation sensors 22, accelerometers, magnetometers, photomultiplier tubes, strain gauges, and other components which incorporate transistors, integrated circuits, resistors, capacitors, and inductors, for example. In the present disclosure, the various electronic components are cooled by evaporation of a liquid as discussed in detail with respect to FIG. 2. Power to operate the exemplary cooling system of the present disclosure and/or the electronic components can be supplied by a battery, a wireline or any other typical power supply method. In other embodiments, power can be supplied by any power supply apparatus including an energy storage device located downhole, such as a battery.

Although the cooling systems disclosed herein is discussed with respect to the exemplary drilling system 10 of FIG. 1, alternate embodiments wherein the cooling system is incorporated into a tool conveyed by a non-rigid conveyance device such as a wireline, slickline, e-line, or coiled tubing, is also considered within the scope of the present disclosure.

Turning now to FIG. 2, there is schematically shown one embodiment of the present disclosure for cooling heat-sensitive components such as electrical components associated with the BHA 14 (FIG. 1), e.g., the sensors 22 and the communication devices 24. These heat-sensitive components will be referred collectively as electronics 54. In one embodiment, the electronics 54 are surrounded by a liquid container 132, which contains a liquid refrigerant such as water (hereafter, ‘liquid’). The liquid container 132 may also be positioned next to electronics 54. The liquid container 132 is in thermal communication with the electronics 54, whether enclosing or adjacent to the electronics 54. The electronics 54 and liquid container 132 may be encased and surrounded by a phase change material 134. If present, the phase change material acts as a temporary heat sink which retards heat flow into the chamber formed by the interior of the phase change material 134. The electronics 54, liquid container 132, and phase change material 134 may be encased and surrounded by an insulating Dewar flask 136. Insulating Dewar flask 136 and phase change material 134 serve as thermal insulator barriers to retard heat flow from surrounding areas into the electronics 54.

Vapor passage 138 runs through Dewar flask 136, phase change material 134 and liquid container 132, thereby providing a vapor escape route from liquid container 132 to desiccant 140. The vapor of the liquid evaporates from the liquid container 132 and passes through vapor passage 138 to desiccant 140 where the vapor is adsorbed. As the water evaporates, the water vapor removes heat from the adjacent electronics 54. Desiccant 140 adsorbs water vapor thereby keeping the vapor pressure low inside of liquid container 132 and facilitating further evaporation and cooling.

Control valve 144 controls the temperature of the liquid inside container 132 by controlling the evaporation pressure of the liquid from liquid container 132. Any suitable component which controls the evaporation rate according to the required cooling power by temporarily retarding the flow of the vapor from lower passage 138a through vapor passage 138 and releasing it again to the upper portion 138b of vapor passage 138 is a suitable control valve. The filter 135 releases the vapor into the upper vapor passage 138b where it travels through the upper vapor passage 138b to desiccant 140. Thus, control valve 144 limits the cooling rate of the electronics during a downhole run to avoid overcooling to an unnecessarily low temperature that would cause more rapid heat flow across Dewar walls and therefore waste water and desiccant.

Desiccant 140 is contained in desiccant chamber 142, which is in thermal contact with down tool housing 52. Downhole tool housing is in thermal contact with borehole annulus containing bore hole mud, thereby enabling heat to flow out of desiccant chamber 142 into the bore hole. Thus, heat is removed from electronics 54, and transmitted to desiccant 140 via the liquid vapor and conducted out of the downhole tool housing 52 to the bore hole.

In embodiments, desiccant 140 is formed of compact zeolite. As used herein, the term “compact” refers to a consolidated solid body. A consolidated body is a body wherein the constituent elements are rigidly fixed to one another. An unconsolidated body is a body wherein the constituent elements can move relative to one another (e.g., a body of sand). In one aspect, a compact zeolite body is a body made up of zeolite particles that have been pre-formed to have a specified geometrical shape that may be complementary to the desiccant chamber 142. The pre-forming may be done using a manufacturing process wherein individual zeolite particles are bound or fused to one another using mechanical (e.g., pressure), thermal, chemical, electrical, and/or other processes. The bonding or fusing that occurs during processing substantially eliminates the “dead space” between the zeolite particles. Thus, the processing binds individual zeolite particles to one another and forms the bound zeolite particles into a predefined shape. As used herein, a predefined shape is a shape not affected by an enclosure receiving the bound zeolite particles.

Prior art desiccant bodies are generally pellets or spherical elements that are not bound to one another, i.e., unconsolidated. Moreover, the pellets are not shaped complementary to a receiving receptacle. Rather, they assume their operational shape only after being poured into a receptacle to form a sorption bed. Normally, a sorption bed of zeolite comprises many zeolite pellets with a different size in diameter. The density of such a pellet-based sorption bed is defined by the close-packing of these spheres. Therefore, in such a sorption bed, there will always be a dead/void volume which is not attributing to the sorption of a gaseous refrigerant. As an example, the bulk density of a zeolite bed made of pellets is 680-760 g/l while the bulk density of zeolite as a compact body is more than 1000 g/l. The significantly greater bulk density may be attributed to the compact body having substantially no interstitial space. Interstitial space is generally the volume that is not occupied by zeolite and cannot adsorb a fluid. For pelletized bodies, the interstitial space between the individual pellets may range to upwards of thirty percent or more of the total body volume. In “compact” bodies, this space may be only one to five percent of the total volume, which for purposes of the present disclosure is substantially no interstitial space (dead space). The elimination of this dead/void volume and the density of the zeolite is a decisive quantity can improve the performance of a downhole sorption cooling system.

A desiccant body may be viewed as having two porosities. The first porosity is that of the zeolite and is associated with the fluid channels within the zeolite itself. The second porosity is due to the spaces between the zeolite particles that allow fluid to migrate through the desiccant body. The inventors have perceived that minimizing the second porosity actually improves the performance of the zeolite body. Testing indicates that a compact zeolite body can store 85 percent more amount of water per volume with respect to the un-compacted zeolite pellets.

FIG. 3 shows another exemplary sorption cooling apparatus 200 suitable for cooling a component of a downhole tool in one embodiment of the present disclosure. The sorption cooling apparatus 200 utilizes the potential energy of sorption as a source of energy to pump heat from a first region of the tool to a second region of the tool. The exemplary sorption cooling apparatus 200 includes a storage tank 202 for storing liquid refrigerant 215, a chamber 204 housing an electronic component of the downhole tool for cooling, and a heat sink region 206 having a desiccant or other solid for gas adsorption. In one embodiment, the chamber 204 housing the electronic component can be inside a Dewars flask. In an alternate embodiment, the storage tank 202 and the cooling chamber 204 can be combined into one chamber with liquid refrigerant and cooling component stored therein. Storage tank 202 stores the refrigerant 215 for use in cooling the component of chamber 204, typically in a liquid phase. In an exemplary embodiment, the refrigerant is water. However, the refrigerant can be any fluid suitable for use as a refrigerant in a downhole environment. A portion of a refrigerant 215 evaporates to cool component 212, thereby keeping the component within a suitable operating temperature range. Valve 210 can be opened to pass liquid refrigerant into chamber 204 where it evaporates into a gaseous phase 232 to draw heat away from the component 212. The spent refrigerant gas 234 (refrigerant gas carrying heat away from component 212) is routed to heat sink region 206. Valve 211 can be opened to allow routing of the refrigerant from chamber 204 to heat sink region 206. At the same time, valve 213 is closed. Upon arriving at the heat sink region 206, the spent refrigerant gas 234 is adsorbed by desiccant 216. The heat sink region 206 can be in thermal contact with the downhole tool housing 240 which is in thermal contact with the wellbore to dissipate heat to the wellbore. The heat sink region 206 includes a desiccant 216 for adsorbing the spent refrigerant gas 234 and an electromagnetic transmitter 218 configured to transmit electromagnetic energy into the desiccant 216 for gas desorption by heating the desiccant. Desorption of the refrigerant gas is also referred to herein as desiccant regeneration. During regeneration valve 211 is closed while the desorbed refrigerant 236 is passed via condenser 208 and valve 213 into storage tank 202.

Transmitter 218 can be activated to transmit electromagnetic energy into the desiccant and/or to the adsorbed refrigerant gas to thereby excite the refrigerant gas to desorb from the desiccant. The sorption cooling apparatus 200 may also include a control unit 220 configured to operate various components of the cooling system. In various embodiments, transmitter 218 transmits radio waves and/or microwaves into the desiccant volume to heat up the adsorbed refrigerant at the desiccant and enable desorption of the refrigerant from the desiccant. Therefore, the refrigerant is recycled for use without bringing the desiccant or the downhole tool to a surface location.

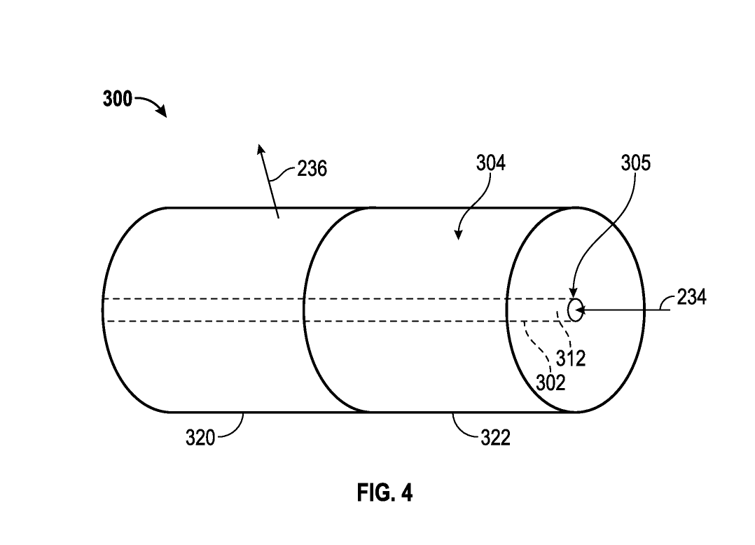

FIG. 4 shows a side view of an exemplary compact desiccant 300 suitable for use in adsorbing refrigerant in the exemplary cooling apparatus 200 (FIG. 2) of the present disclosure. The exemplary desiccant can be a molecular sieve formed of a compact zeolite. In an exemplary embodiment, desiccant 300 is in the shape of an annular cylinder having a continuous inner surface 302 and a continuous outer surface 304. The desiccant 300 is a solid body as opposed to being formed of individual zeolite pellets that are not fused or bonded to one another. Thus, the surfaces 302, 304 are structurally continuous instead of segmented or particulated as with individual zeolite pellets. It should be appreciated that in certain embodiments, the bound zeolite particles can collectively form a receiving surface wherein a fluid can enter and a dissipating surface from which the fluid can exit. The receiving surface may be an internal surface and the dissipating surface may be an external surface, or vice versa. In some embodiments, the receiving surface and the dissipating surface may be the same surface. In other embodiments, the receiving surface and the dissipating surface may be different surfaces.

The spent refrigerant 234 is introduced from the cooling chamber into a central region 305 and is adsorbed onto the annular cylinder volume by a process of adhesion of the refrigerant molecules onto the compact zeolite desiccant. In some embodiments, the inner surface 302 can define a porous inlet 310 and a passage 312. The refrigerant gas may flow through the passage 312 and into central region 305 of the desiccant. Desorbed gas 236 can exit the desiccant 300 through outer surface 304. While one passage 312 is shown, more passages may be used. It should be understood that the fluid flow can also be reversed, i.e., from the outer surface 304 to the inner surface 302. The inflowing refrigerant vapor may enter the body 300 axially at one or both ends or may enter the body 300 laterally through one or more radially aligned passages. Moreover, the cylindrical shape is merely illustrative and not-limiting.

The FIG. 4 embodiment includes a first compact desiccant body 320 that is attached to a second compact desiccant body 322. Each of the bodies 320, 322 include individual zeolite particles. While two compact desiccant bodies are shown, more may be used. Further, in some embodiments, the bodies arranged differently; e.g., concentrically instead of serially. The compact desiccant bodies 320, 322 may be mechanically attached using a process such as pressing. Adhesives, chemical, or thermal processes may also be used to attach the bodies 320, 322 to one another.

The inner surface 302 and outer surface 304 can further include various electrodes for electric or electromagnetic heating and measuring properties like saturation or temperature of the desiccant. In some embodiments, electrodes may be used to determine a saturation level of the desiccant. Therefore, the determined impedance can be compared to a selected impedance criterion to determine if the desiccant is at or above a selected saturation level. If the selected saturation criterion is met, the processor can activate the electrodes to transmit electromagnetic energy into the desiccant volume to enable the refrigerant gas to desorb from the desiccant.

As discussed above, a manufacturing process may be used to pre-form the desiccant 300 into the shape of an annular cylinder. Thus, the annular cylinder is a substantially solid body formed of bonded or fused zeolite particles that may be received into the heat sink region 206. Thus, the heat sink region 206 has a bore that is complementary to the annular cylinder shape. By complementary, it is meant the body of the desiccant 300 and the heat sink region 206 may have one or more structural features that are geometrically similar, e.g., a cylindrical inner surface of the heat sink region 206 that is matched to a cylindrical outer surface of the body of the desiccant 300. Thus, the shape of the desiccant body 300 does not change after being inserted into the heat sink region 206. It should be noted that prior art desiccants, which are granular, only assume the shape of the receiving heat sink region after being poured into that region. In certain embodiments, the desiccant 300 may be into two or more sections. Still, each section is pre-formed to be a compact zeolite body.

While the foregoing disclosure is directed to the one mode embodiments of the disclosure, various modifications will be apparent to those skilled in the art. It is intended that all variations within the scope of the appended claims be embraced by the foregoing disclosure.

1. A sorption cooling apparatus for cooling a region in a downhole tool deployed on a wellbore conveyance device, comprising:
a container having an interior chamber, the container being associated with the downhole tool;
a refrigerant residing in the interior chamber;
a chamber located in the downhole tool;
a compact desiccant body in the chamber; and
a refrigerant passage between the first region containing the refrigerant and the interior chamber containing the compact desiccant body, wherein vapor generated during evaporation of the refrigerant passes through the vapor passage to the compact desiccant.

2. The apparatus of claim 1 wherein the compact desiccant body is a compact zeolite body.

3. The apparatus of claim 2 wherein the compact zeolite body is preformed into a shape complementary to the chamber.

4. The apparatus of claim 3 wherein the compact zeolite has substantially no interstitial space.

5. The apparatus of claim 2 wherein zeolite particles making up the compact zeolite body are bonded to one another.

6. The apparatus of claim 2, wherein the compact zeolite body has a continuous inner surface for receiving the vapor and a continuous outer surface.

7. A sorption cooling apparatus for cooling a region in a downhole tool deployed on a wellbore conveyance device, comprising:
a container having an interior chamber, the container being associated with the downhole tool;
a refrigerant residing in the interior chamber;
a chamber located in the downhole tool;
a consolidated, compact zeolite body in the chamber, the compact zeolite body being preformed into a shape complementary to the chamber, the compact zeolite body being formed of individual zeolite particles having substantially no interstitial space; and
a refrigerant passage between the interior chamber containing the refrigerant and the compact desiccant body, wherein vapor generated during evaporation of the refrigerant passes through the vapor passage to the compact desiccant.

8. The apparatus of claim 7, wherein the compact zeolite particles are preprocessed to have bound zeolite particles, and wherein the bound zeolite particles collectively form a receiving surface and a dissipating surface, wherein the vapor enters through the receiving surface.

9. The apparatus of claim 8, wherein the receiving surface is internal to the compact zeolite body and the dissipating surface is external to the compact zeolite body.

10. The apparatus of claim 8, wherein the individual zeolite particles are fixed to one another such that they cannot move relative to one another.

11. A method for cooling a region in a downhole tool deployed on a wellbore conveyance device, comprising:
forming an interior chamber in a first container associated with the downhole tool, the interior chamber having a refrigerant;
disposing a compact desiccant body in the downhole tool, wherein a refrigerant passage connects the interior chamber containing the refrigerant and the compact desiccant body; and
passing vapor generated during evaporation of the refrigerant through the vapor passage to the compact desiccant.

12. The method of claim 11 wherein the compact desiccant body is a compact zeolite body.

13. The apparatus of claim 12 wherein the compact zeolite body is preformed into a shape complementary to the chamber.

14. The apparatus of claim 13 wherein the compact zeolite has substantially no interstitial space.

15. The apparatus of claim 12 wherein zeolite particles making up the compact zeolite body are bonded to one another.

16. The apparatus of claim 12, wherein the compact zeolite body has a continuous inner surface for receiving the vapor and a continuous outer surface.
